(19) United States
(12) Patent Application Publication
(10) Pub. No.: US 2001/0026671 A1
(43) Pub. Date: Oct. 4, 2001

(54) Waveguide optical device

(75) Inventor: Junichi Kinoshita, Yokohama-Shi (JP)

Correspondence Address: HOGAN & HARTSON L.L.P., 500 S. GRAND AVENUE, SUITE 1900, LOS ANGELES, CA, 90071-2611, US

(73) Assignee: KABUSHIKI KAISHA TOSHIBA

(21) Appl. No.: 09/819,225

(22) Filed: Mar. 27, 2001

(30) Foreign Application Priority Data
Mar. 28, 2000 (JP) 2000-89338

(51) Int. Cl. G02B 6/12

(52) U.S. Cl. 385/129; 372/43; 385/132; 385/40; 385/14

(57) ABSTRACT

A waveguide of an optical device is formed by a ridge waveguide portion which is formed as a substantially stripe convex portion extending in a guiding direction, and a gain waveguide portion which guides light in a gain region optically coupled with the ridge waveguide portion. An extended portion is formed to extend from the gain waveguide portion in the lateral direction of the waveguide. With this extended portion, an electrode and a pad are connected by a planar structure on the flat surface continuing from the upper surface of the ridge waveguide portion, without using any resin step. A phase shift effect is also obtained in the gain waveguide portion.

### CROSS REFERENCE TO RELATED APPLICATIONS

This application claims benefit of priority under 35USC §119 to Japanese Patent Application No. 2000-89338, filed on Mar. 28, 2000 in Japan, the entire contents of which are incorporated by reference herein.

### BACKGROUND OF THE INVENTION

The present invention relates to a waveguide optical device. More specifically, the present invention relates to a waveguide optical device such as a semiconductor laser or optical modulator having a ridge waveguide, capable of realizing a stop coveraged metal layer for electrical connections and achieving the effect of phase shift by using a part of the waveguide as a gain type waveguide.

Examples of an optical device having a waveguide are various light-emitting devices such as a semiconductor laser, an optical modulator, and diverse light-detecting devices (receivers) such as a waveguide photodiode. For example, a structure called a “ridge waveguide (RWG)” is known as a semiconductor laser. This structure has a stripe waveguide so fabricated that a cladding layer above an active layer has a convex section. In a waveguide of this type, a stripe portion including the active layer below the ridge formed in the cladding layer functions as a waveguide to guide light.

FIG. 8 is a perspective view showing a typical structure of a ridge waveguide semiconductor laser relevant to the present invention. That is, this laser shown in FIG. 8 is an InGaAsP/InP-based semiconductor laser used in the field of long-distance, high-speed optical communications. An outline of the structure of this laser will be described below.

An n-InP lower cladding layer 2, an InGaAsP waveguide core layer/active layer 3 having an MQW (multiple-quantum well) structure, a p-InP first upper cladding layer 4, a p-InGaAsP etching stop layer 5, a p-InP second upper cladding layer 6, a p-InGaAsP barrier buffer layer 7, and a p⁺-InGaAs contact layer 8 are stacked in this order on an n-InP substrate 1. The barrier buffer layer 7 is formed to buffer the rectification properties by the barrier between the p⁺-InGaAs contact layer 8 and the p-InP second upper cladding layer 6.

The p-type second upper cladding layer 6, the p-type barrier buffer layer 7, and the p⁺-type contact layer 8 above the p-type etching stop layer 5 are patterned into a stripe about, e.g., 2 μm wide, thereby forming a ridge waveguide having a convex section.

In addition, a p-side electrode 20 and an n-side electrode 21 are formed on the upper and lower surfaces of the device.

A ridge waveguide semiconductor laser having the above construction can readily accomplish high-speed response since, when the ridge width is decreased, the parasitic capacitance can be decreased accordingly.

In this specification, a structure in which, for example, the active layer 3 serving as the core of a waveguide or layers below this active layer 3 are patterned into the shape of a mesa is also defined as a “ridge waveguide”, in addition to the structure shown in FIG. 8.

Unfortunately, the ridge waveguide semiconductor laser as shown in FIG. 8 has a problem that disconnection of metal layers at the corners readily occurs when the electrodes are formed on the upper surface of the ridge.

Specifically, to supply an electric current to the p-side electrode 20 formed into the shape of a stripe on the upper surf ace of the ridge, it is necessary to form an electrode pad 30 extending from this p-side electrode 20 to the bottom surface via the step of the ridge, and connect this electrode pad 30 to an external power supply by bonding a gold wire 40 to the electrode pad 30 on the bottom surface. An SiO₂ film 100 for electrical insulation is also necessary below the electrode pad 30 and on the side walls of the ridge.

When a thin film formation process is performed in such a portion as including the steps of the ridge, however, insulation may be broken by “poor step coverage” of the SiO₂ film 100, or the electrode pad 30 may also cause “poor step coverage” to often result in a connection failure for the p-side electrode 20.

One modification of the ridge waveguide is a so-called “buried waveguide structure” in which a waveguide layer projecting into the shape of a stripe is formed and a medium having a low refractive index is buried around the stripe. In this construction, a flat surface can be formed by burying the steps of the ridge. However, the formation of this buried waveguide construction requires an additional crystal growth step for the burying process.

A resin such as polyimide can also be used to planarize the ridge. A planar electrode patterns on the same level and the top surface of the ridge is most ideally and desirable.

FIG. 9 shows a modification of a ridge waveguide semiconductor laser sample fabricated by the present inventor. In FIG. 9, the same reference numerals as in FIG. 8 denote the same parts explained above in connection with FIG. 8, and a detailed description thereof will be omitted.

In the semiconductor laser shown in FIG. 9, a polyimide base 200 is formed to be connected to a portion of the ridge. The upper surface of the ridge is substantially flush with the upper surface of the base 200. An electrode pad 30 is so formed as to extend on the upper surface of this base 200, and a gold wire 40 is bonded to this electrode pad 30.

When the base 200 as described above is formed, it is possible to eliminate the step of the ridge and prevent an electrically open failure caused by “poor step coverage”, i.e., disconnection of metal layers at the corners of the ridge. However, the results of this sample by the present inventor reveal that the formation of this structure also has several problems. That is, to form the base 200, it is necessary to coat the entire wafer surface with polyimide, expose the top of the ridge by gradually thinning the whole structure, and pattern the polyimide. Unfortunately, it is not easy to expose the ridge upper surface and pattern the polyimide. Cure process is also necessary for hardening the resin (polyimide). Furthermore, the volume of the resin reduces by the cure, and hygroscopicity resulting from insufficient cure often deteriorates the reliability.

### SUMMARY OF THE INVENTION

The present invention has been made to overcome the above problems, and has its object to provide a waveguide optical device having a ridge waveguide, by which an electrode and a pad can be connected by a planar structure without using any resin step.

To achieve the above object, a waveguide optical device of the present invention is an optical device comprising a waveguide for guiding light, characterized in that the waveguide comprises a ridge waveguide portion formed as a substantially stripe convex portion extending in a guiding direction, and a gain waveguide portion which guides light in a gain region optically coupled with the ridge waveguide portion.

This device further comprises an electrode formed on the upper surface of the waveguide, an extended portion extending from the gain waveguide portion in the lateral direction of the waveguide, and an electrode pad connected to the electrode and extending on the upper surface of the extended portion. Accordingly, the electrode pad can be connected on the flat surface continuing from the upper surface of the ridge waveguide portion. This can eliminate problems such as poor step coverage.

When the resistance in at least a part of the extended portion is increased to suppress injection of an electric current from the electrode pad, the guiding efficiency of the gain waveguide portion can be increased.

The guiding efficiency of the gain guiding portion can also be increased by forming an insulating layer between the electrode pad and at least a part of the extended portion, in order to suppress injection of an electric current from the electrode pad.

To maintain high guiding efficiency, the length of the gain waveguide portion is desirably 1/10 or less the overall length of the waveguide.

The device further comprises a diffraction grating formed along the waveguide to give optical perturbation to guided light, wherein the gain guiding portion has a substantially phase shift effect on light guided along the waveguide. In this case, the phase conditions of waveguide mode can be optimized.

When the waveguide optical device is a distributed feedback laser which generates laser oscillation in the waveguide, the phase shift effect of the gain waveguide portion can change in accordance with a bias current or threshold current supplied to the laser.

When the change in the phase shift effect is designed to cancel chirping, it is possible to realize a laser which does not vary the wavelength even when performing direct modulation. When a laser is directly modulated, a wavelength variation called chirping generally occurs. This causes a degradation of signals after long-distance transmission by dispersion of an optical fiber. The present invention can avoid this phenomenon.

As described above, the present invention can provide various waveguide optical devices having high performance and high reliability with a simple arrangement, so the industrial merit of the invention is enormous.

### BRIEF DESCRIPTION OF THE DRAWINGS

FIG. 1 is a view for conceptually showing a plan arrangement of a waveguide optical device according to the present invention;

FIG. 2 is a perspective view showing the structure of a semiconductor laser as the first embodiment of the present invention;

FIGS. 3A and 3B are sectional views taken along lines A-A and B-B, respectively, in FIG. 2;

FIG. 4 is a perspective view showing the structure of a semiconductor laser subjected to proton bombardment;

FIGS. 5A and 5B are sectional views taken along lines A-A and B-B, respectively, in FIG. 4;

FIG. 6A is a perspective view of a semiconductor laser as the second embodiment of the present invention, and FIG. 6B is a conceptual view showing the main parts of a waveguide W;

FIG. 7 is a conceptual view showing the main components of a DFB laser having an HR/AR structure according to the present invention;

FIG. 8 is a perspective view showing a typical structure of a ridge waveguide semiconductor laser relevant to the present invention; and

FIG. 9 is a view showing a modification of a ridge waveguide semiconductor laser sample fabricated by the present inventor.

### DESCRIPTION OF THE PREFERRED EMBODIMENTS

One point of the present invention is that a portion of a ridge waveguide is replaced with a gain waveguide gain guide to form an extended portion which extends flat sideways from the upper surface of the ridge. In this flat portion of the gain waveguide, an electrode pad or an electrode itself can be formed without “poor step coverage”. Furthermore, in a waveguide having a diffraction grating, this gain waveguide portion can also be functioned as an effective “phase shift region”.

Embodiments of the present invention will be described in detail below with reference to the accompanying drawings.

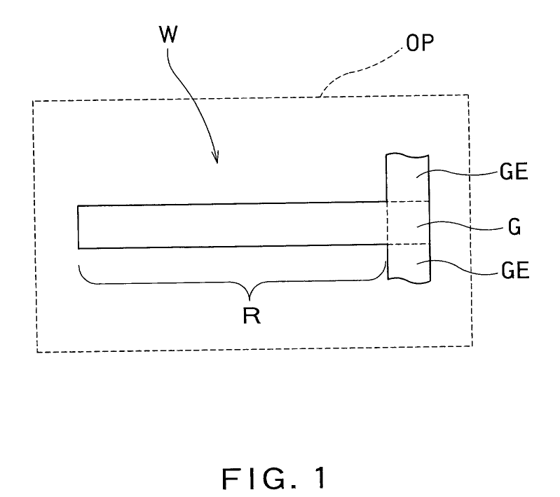

FIG. 1 is a view for conceptually explaining the plan arrangement of a waveguide optical device according to the present invention.

Specifically, a waveguide optical device OP of the present invention is, e.g., a light-emitting device, optical modulator, or light-detecting device (receiver), and has a waveguide W. This waveguide W includes a ridge waveguide portion R and a gain waveguide portion G.

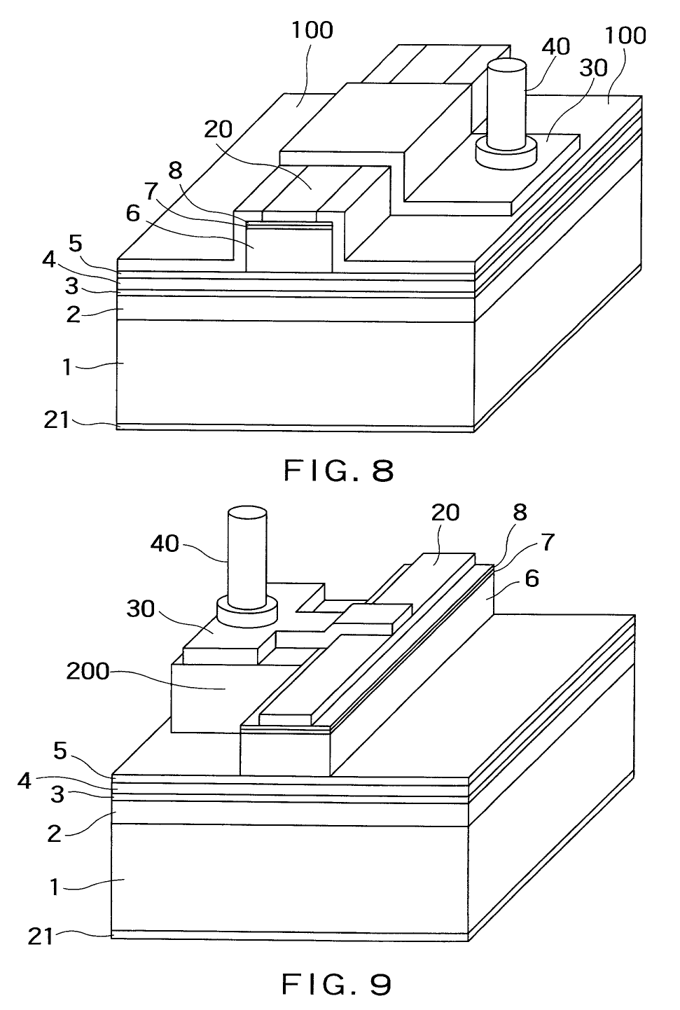

The ridge waveguide portion R is typically a waveguide which projects into substantially the shape of a mesa and guides light by the difference in refractive index between this mesa and a medium on the two sides in the lateral direction of the mesa. As described earlier in connection with FIG. 8, the mesa may or may not contain a core.

The gain waveguide portion G is a waveguide which does not guide light by refractive index difference, but in which light is guided in a high-gain region. More specifically, when there is no index difference, light is amplified by stimulated emission in a high-gain region. As a result, this high-gain region (gain region) functions as a waveguide region. Accordingly, it is unnecessary to form steps produced during mesa formation in the gain waveguide G, and an electrode need only be a stripe pattern. Therefore, electrical connection to an electrode pad for wire bonding can be formed by a planar structure by using this portion as a path.

In a gain guide, light is emitted from a portion near the center in which the gain is high. Hence, the wave front of a traveling wave has a shape whose central portion projects in the traveling direction. A gain region like this can be formed only by selectively injecting an electric current in the guiding direction. For example, it is possible to selectively inject an electric current via a stripe electrode or by forming a current blocking layer outside of the stripe.

As shown in FIG. 1, the waveguide optical device OP of the present invention has a structure in which a portion of the ridge waveguide is replaced with the gain waveguide portion G. This device also has an extended portion GE which extends flat sideways from the gain waveguide portion G to the waveguide W. When an electrode pad is formed across the upper surface of this extended portion GE, no problems such as “poor step coverage” occur.

Furthermore, when a waveguide has a diffraction grating as will be described in detail later as an embodiment of the present invention, the gain waveguide portion G can be functioned as a substantially “phase shift”.

Although FIG. 1 shows an example in which the gain guiding portion G is formed at the edge of the waveguide W, the present invention is not limited to this example. For example, the gain guiding portion G can also be formed in the middle of the waveguide W.

Also, the extended portion GE need not be formed on both sides of the waveguide W, but can be formed only on one side. The planar shape of this extended portion GE is also not limited to a rectangular shape and can be various shapes, as will be described in detail later as embodiments.

Embodiments of the present invention will be described in detail below with reference to the accompanying drawings.

### First Embodiment

As the first embodiment of the present invention, a waveguide optical device of the present invention which corresponds to the semiconductor laser shown in FIG. 8 will be explained.

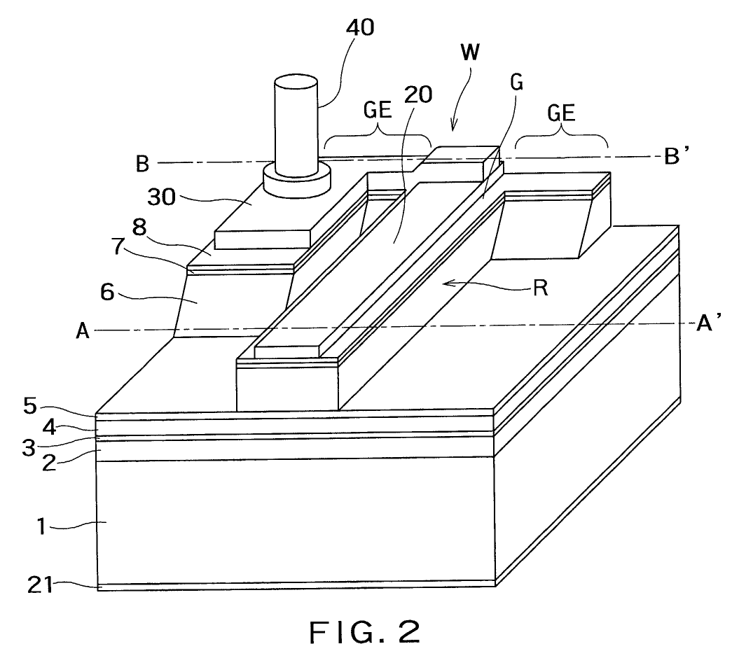

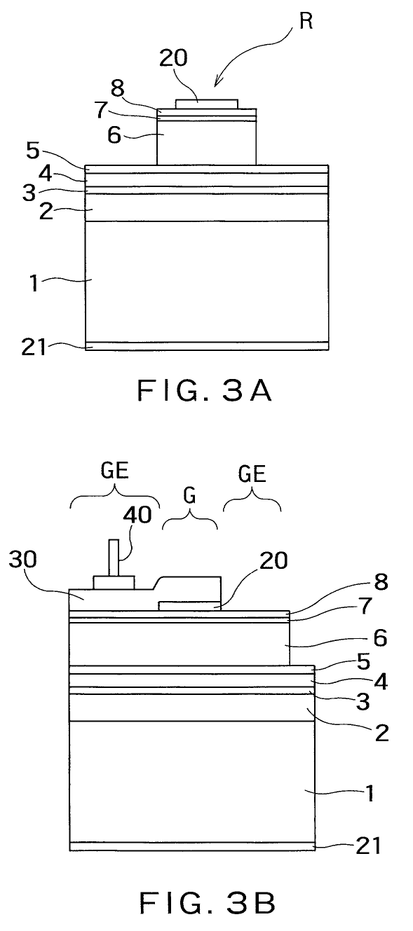

FIG. 2 is a perspective view showing the structure of the semiconductor laser as the first embodiment of the present invention. FIGS. 3A and 3B are sectional views taken along lines A-A and B-B, respectively, in FIG. 2. In FIGS. 2, 3A, and 3B, the same reference numerals as in FIG. 8 denote the same parts described previously in connection with FIG. 8.

The semiconductor laser of this embodiment is a ridge waveguide semiconductor laser, i.e., an InGaAsP/InP-based semiconductor laser which is used in the field of long-distance, high-speed optical communications and which oscillates in a wavelength of 1.3 to 1.55 μm. The structure of this laser will be described below following the fabrication procedure.

First, an n-InP lower cladding layer 2, an InGaAsP waveguide core layer/active layer 3 (about 0.1 μm thick) having an MQW (multiple-quantum well) structure, a p-InP first upper cladding layer 4 (about 0.15 μm thick), a p-InGaAsP etching stop layer 5 (about 0.05 μm thick), a p-InP second upper cladding layer 6 (about 1.3 μm thick), a p-InGaAsP barrier buffer layer 7 (about 0.04 μm thick), and a p⁺-InGaAs contact layer 8 (about 0.1 μm thick) are formed flat by crystal growth on an n-type (100) InP substrate 1. The barrier buffer layer 7 is formed to buffer the rectification properties by the barrier between the p⁺-InGaAs contact layer 8 and the p-InP second upper cladding layer 6. This barrier buffer layer 7 has a bandgap corresponding to a 1.3-μm band which is an intermediate composition between these layers 6 and 8.

Subsequently, a sulfuric acid-based etchant (e.g., 4 sulfuric acid+1 hydrogen peroxide+1 water) is used to etch away the p-InGaAsP barrier buffer layer 7 and the p⁺-InGaAs contact layer 8, except for a stripe portion about 2 μm wide and a portion serving as an extended portion GE.

These layers are used as masks to perform etching by using a hydrochloric acid (HCl)-based etchant. Consequently, the p-InP second upper cladding layer 6 is substantially vertically etched down up to the p-InGaAsP etching stop layer 5. Since the HCl-based etchant acts only on InP, this etching accurately stops at the etching stop layer 5. Accordingly, it is possible to integrally form a ridge waveguide having a convex section and an extended portion GE which extends into a predetermined shape on the two sides of a portion of this ridge waveguide. In addition, the upper surface from the ridge waveguide to the extended portion GE can be formed flat.

In the above-mentioned etching step, dry etching such as RIE (Reactive Ion Etching), CDE (Chemical Dry Etching), or ion milling can be used instead of wet etching using a sulfuric acid- or hydrochloric acid-based etchant.

Subsequently, a stripe p-side electrode 20 is formed on the waveguide W, and an n-side electrode 21 is formed on the rear surface of the substrate 1. Also, an electrode pad 30 extending from the p-side electrode 20 to the extended portion GE is formed. Finally, a wire 40 is bonded near the end portion of the electrode pad 30 to complete wiring.

The waveguide W of the semiconductor laser thus formed has a ridge waveguide portion R which guides light by the refractive index difference in the lateral direction, and a gain waveguide portion G which guides light in a gain region by selectively injecting an electric current from the stripe electrode. The electrode pad 30 can be formed without “poor step coverage” across the extended portion GE extending flat from the gain waveguide portion G.

The region of the gain guiding portion G is desirably about 10% or less of the waveguide W, i.e., the entire resonator length. That is, when the overall length of the waveguide W is 200 to 300 μm, the length in the guiding direction of the gain waveguide portion G is limited to approximately 20 to 30 μm. The reason is that laser oscillation by gain guiding has a high threshold, so the transverse mode readily becomes unstable. The electrical connection between the electrode pad 30 and the p-side electrode can be well ensured with a size like this.

Accordingly, in the present invention, the length of the gain waveguide portion G is desirably as small as possible. This allows planar connection of the electrode without deteriorating the low threshold value and the stable transverse mode characteristic.

To clearly define a portion which functions as a waveguide in the grin guiding portion G, it is necessary to accurately define a portion where an electric current is injected into the active layer 3 and suppress injection of the current in a portion other than the waveguide portion. For this purpose, it is possible to form an insulating layer (not shown) below the electrode pad 30 or form a current blocking layer (not shown), which has an opening corresponding to the guiding region, between the electrode and the active layer, thereby suppressing injection of an electric current in a portion other than the waveguide portion.

When the resistance of a portion other than the waveguide, i.e., of the extended portion GE is increased by proton bombardment, the function of gain guiding is made more effective.

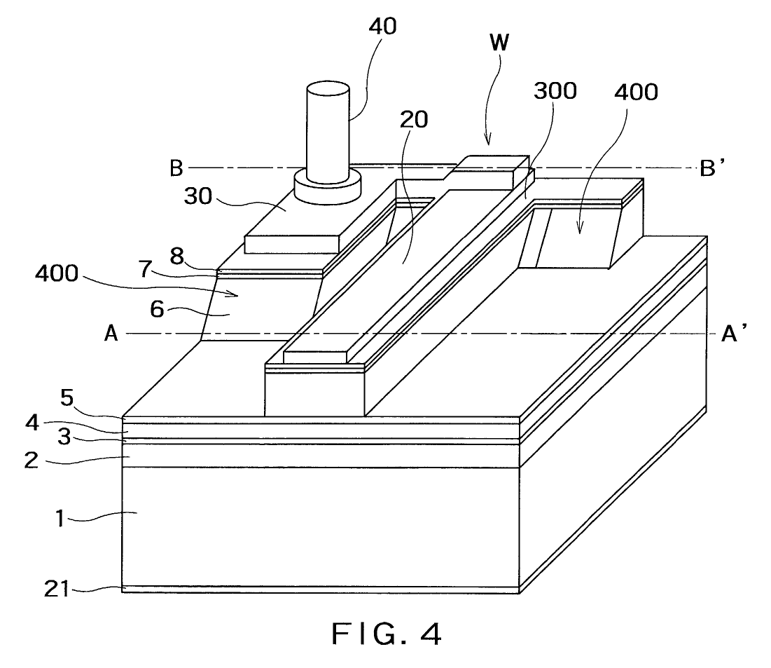

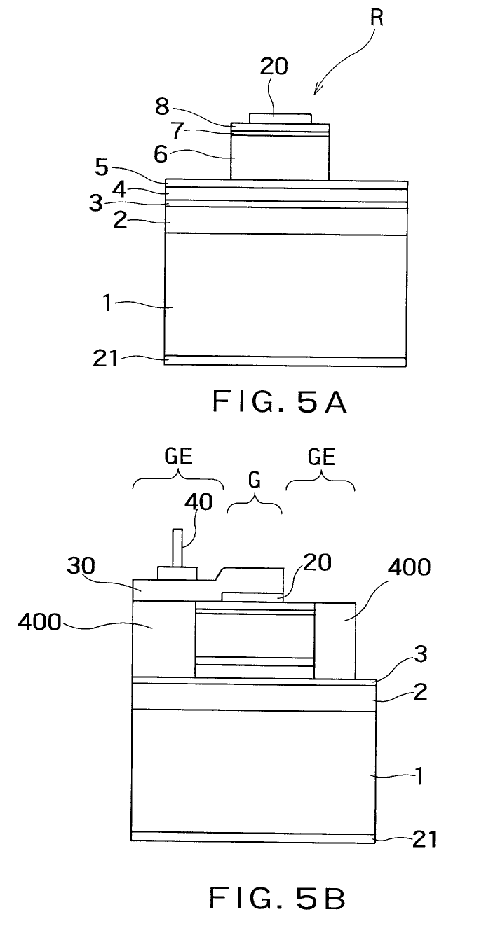

FIG. 4 is a perspective view showing the structure of a semiconductor laser subjected to proton bombardment. FIGS. 5A and 5B are sectional views taken along lines A-A and B-B, respectively, in FIG. 4. In FIGS. 4, 5A, and 5B, the same reference numerals as in FIGS. 1, 2, and 8 denote the same parts explained earlier in connection with FIGS. 1, 2, and 8.

In the semiconductor laser shown in FIGS. 4, 5A, and 5B, a high-resistance region 400 is formed in the extended portion GE by proton bombardment. When the high-resistance region 400 is thus formed, the guiding efficiency can be improved by selectively injecting an electric current into the gain waveguide portion G. In this modification, the use of proton bombardment can also realize insulation between a portion below the electrode pad 30 and the electrode pad without forming any oxide film or resin.

### Second Embodiment

The second embodiment of the present invention will be described below.

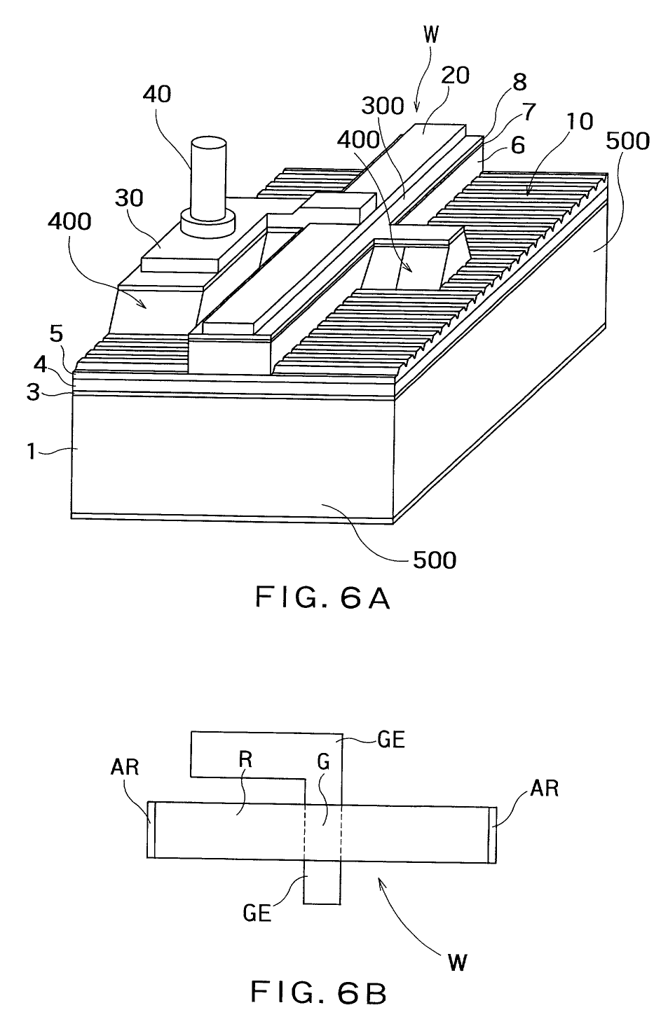

FIG. 6A is a perspective view of a semiconductor laser as the second embodiment of the present invention. FIG. 6B is a conceptual view showing the main parts of a waveguide W and an extended portion GE. In FIGS. 6A and 6B, the same reference numerals as in FIGS. 1 to 5B and 8 denote the same parts described earlier in connection with FIGS. 1 to 5B and 8, and a detailed description thereof will be omitted.

As in the first embodiment, the semiconductor laser of this embodiment is an InGaAsP/InP semiconductor laser formed on an n-type (100) InP substrate. The difference from the first embodiment is that a diffraction grating 10 is formed on an etching stop layer 5 to obtain a DFB (Distributed FeedBack) laser. Also, a gain waveguide portion G is formed near the center of the waveguide W, i.e., a resonator, and an AR (Anti-Reflection) coating is formed on end faces 500 at the two ends.

Also in this embodiment, it is possible to obtain the effect that an electrode pad 30 can be formed without “poor step coverage” across the extended portion GE extending flat from the gain waveguide portion G.

Furthermore, in this embodiment, the gain waveguide portion G can also be functioned as an effective “phase shift”. That is, when a DFB laser having two anti-reflection end faces is formed as a so-called λ/4 phase shift DFB laser by shifting the phase of a diffraction grating in the center of its resonator by a wavelength which is ¼ the waveguide wavelength, the single longitudinal mode performance is generally improved for the following reason. That is, a uniform diffraction grating cannot satisfy the phase conditions because the sum of phase shifts caused by reflection on the two sides is π as the Bragg wavelength. However, when a “phase shift” is formed, the phase conditions can be met at the Bragg wavelength, so oscillation at the Bragg wavelength can be obtained.

The gain guiding portion G of this embodiment changes its effective refractive index with respect to a ridge waveguide portion R before and after the gain waveguide portion G. This achieves an effective “phase shift”. As a consequence, it is possible to readily implement a λ/4 phase shift DFB laser and obtain oscillation at the Bragg wavelength by a low threshold value.

Also, in the gain guiding portion G, the effective waveguide width changes in accordance with a current amount injected. Accordingly, the amount of an effective “phase shift” can be easily changed by an electric current, i.e., the threshold current of the laser or the applied bias. As described above, a wavelength variation called “chirping” usually occurs when a laser is directly modulated. This deteriorates the signals after long-distance transmission by dispersion of an optical fiber. A DFB laser having little chirp can be implemented by designing a change in the effective phase shift amount with the injected current amount so as to cancel this wavelength chirp.

That is, the spread of an electric current inside a laser changes in accordance with the injected current amount, and the mode, light density distribution, or refractive index changes accordingly. Therefore, it is possible to suppress the wavelength chirp by controlling these parameters by adjusting the size and material parameters of the gain waveguide portion G.

Some DFB lasers have a so-called “HR/AR structure” in which an HR (High-Reflectivity) coating is formed on one end face and an AR (Anti-Reflectivity) coating is formed on the other. The present invention is also applicable to a DFB laser having this HR/AR structure.

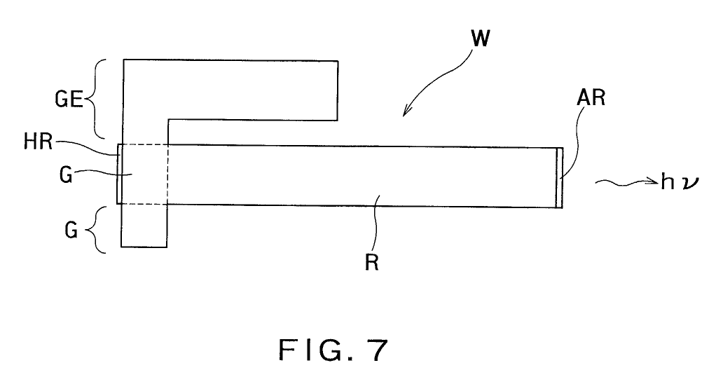

FIG. 7 is a schematic view showing the major components of an HR/AR DFB laser to which the present invention is applied. That is, a high-reflectivity (HR) coating is formed on one end face of a waveguide W of the DFB laser, and an anti-reflectivity (AR) coating is formed on the other. A gain waveguide portion G is formed near the HR end face of the waveguide W, and the rest is formed by a ridge waveguide portion R.

In this modification, an effective “phase shift” can be generated in the gain waveguide portion G formed near the HR end face. As a consequence, it is possible to cause the laser to oscillate at the Bragg wavelength by a low threshold current while the phase conditions are met, and obtain a high optical output from the AR end face.

The embodiments of the present invention have been explained with reference to practical examples. However, the present invention is not limited to these practical examples. For example, if appropriate etchants exist, similar effects can be obtained by applying the present invention to waveguide optical devices made of various materials such as GaAs/AlGaAs, InGaAlP, InAlGaN, and ZnSe, in addition to the InGaAsP/InP described above.

Analogous effects can also be obtained by applying the present invention to various optical devices having a ridge waveguide, such as a waveguide light-receiving device and waveguide optical modulator, in addition to a semiconductor laser.

Furthermore, similar effects can be obtained by applying the present invention to an optical integrated circuit device fabricated by combining a light-emitting device and optical modulator, a light-emitting device and light-receiving device, or an optical modulator device and light-receiving device.

In the present invention as has been described in detail above, it is possible by replacing a portion of a ridge waveguide with a gain waveguide to achieve the effect of forming an extended portion which extends flat from the gain guiding portion and forming an electrode pad on this extended portion. Consequently, it is possible to suppress “poor step coverage”, eliminate an insulation failure and contact failure, and realize stable electrical connection having excellent high-frequency characteristics and high long-term reliability.

In addition, the present invention obviates the need to bury the ridge waveguide or form a resin base, and thereby can avoid complication of the device structure and the fabrication steps.

Also, the present invention uses a method of selectively injecting proton into the gain guiding portion. This can clearly define a gain region functioning as a waveguide and achieve a high guiding efficiency.

Furthermore, the present invention makes the gain guiding portion function as an effective “phase shift”. This can further improve the oscillation characteristics of the DFB laser in addition to the above effects.

What is claimed is:

1. A waveguide optical device comprising a waveguide for guiding light, wherein
said waveguide comprises a ridge waveguide portion formed as a substantially stripe convex portion extending in a guiding direction, and a gain waveguide portion which guides light in a gain region optically coupled with said ridge waveguide portion.

2. A device according to claim 1, further comprising:
an electrode formed on the upper surface of said waveguide;
an extended portion extending from said gain waveguide portion in the lateral direction of said waveguide; and
an electrode pad connected to said electrode and extending on the upper surface of said extended portion.

3. A device according to claim 2, wherein the resistance in at least a portion of said extended portion is increased to suppress injection of an electric current from said electrode pad.

4. A device according to claim 3, wherein the length of said gain waveguide portion is not more than 1/10 the overall length of said waveguide.

5. A device according to claim 4, further comprising a diffraction grating formed along said waveguide to give optical perturbation to light to be guided,
wherein said gain waveguide portion has a substantially phase shift effect on light guided in said waveguide.

6. A device according to claim 5, wherein said waveguide optical device is a distributed feedback laser which generates laser oscillation in said waveguide, and the phase shift effect of said gain waveguide portion changes in accordance with a bias current or threshold current supplied to said laser.

7. A device according to claim 6, wherein the change in the phase shift effect is so produced as to cancel chirping.

8. A device according to claim 2, wherein an insulating layer is formed between said electrode pad and at least a part of said extended portion, in order to suppress injection of an electric current from said electrode pad.

9. A device according to claim 8, wherein the length of said gain waveguide portion is not more than 1/10 the overall length of said waveguide.

10. A device according to claim 9, further comprising a diffraction grating formed along said waveguide to give optical perturbation to light to be guided,
wherein said gain waveguide portion has a substantially phase shift effect on light guided in said waveguide.

11. A device according to claim 10, wherein said waveguide optical device is a distributed feedback laser which generates laser oscillation in said waveguide, and the phase shift effect of said gain waveguide portion changes in accordance with a bias current or threshold current supplied to said laser.

12. A device according to claim 11, wherein the change in the phase shift effect is so produced as to cancel chirping.

13. A device according to claim 2, wherein the length of said gain waveguide portion is not more than 1/10 the overall length of said waveguide.

14. A device according to claim 2, further comprising a diffraction grating formed along said waveguide to give optical perturbation to light to be guided,
wherein said gain waveguide portion has a substantially phase shift effect on light guided in said waveguide.

15. A device according to claim 1, wherein the length of said gain waveguide portion is not more than 1/10 the overall length of said waveguide.

16. A device according to claim 15, further comprising a diffraction grating formed along said waveguide to give optical perturbation to light to be guided,
wherein said gain waveguide portion has a substantially phase shift effect on light guided in said waveguide.

17. A device according to claim 16, wherein said waveguide optical device is a distributed feedback laser which generates laser oscillation in said waveguide, and the phase shift effect of said gain waveguide portion changes in accordance with a bias current or threshold current supplied to said laser.

18. A device according to claim 17, wherein the change in the phase shift effect is so produced as to cancel chirping.
